(19) United States
(12) Patent Application Publication
(10) Pub. No.: US 2019/0090070 A1
(43) Pub. Date: Mar. 21, 2019

(54) A Hearing Device and A Method of Adapting A Hearing Device

(71) Applicant: Sonova AG, Staefa (CH)

(72) Inventors: Jan Angst, Hirzel (CH); Erdal Karamuk, Maennedorf (CH); Hilmar Meier, Herrliberg (CH)

(73) Assignee: Sonova AG, Staefa (CH)

(21) Appl. No.: 16/082,282

(22) PCT Filed: Mar. 9, 2016
(86) PCT No.: PCT/EP2016/055059

§ 371 Date: Sep. 5, 2018

(51) Int. Cl. H04R 25/00

(52) U.S. Cl. CPC H04R 25/554; H04R 25/505; H04R 2225/025; H04R 2225/55; H04R 2225/021; H04R 25/65

(57) ABSTRACT

The present invention relates to a hearing device (10) comprising an electronic module (12) having at least one processor (14), a housing (18) for accommodating the electronic module (12), and at least one user control assembly (20) comprising at least one user control unit (22′-22′″), accessible by a user of the hearing device (10). Said hearing device (10) further comprises at least one connector interface (24) operationally coupled to the electronic module (12), wherein said user control assembly (20) is detachably mounted to the housing (18), and said connector interface (24) is adapted to receive inputs from a plurality of different user control assemblies (20) and transfer said inputs to the electronic module (12) via at least one coupling means (28).

### TECHNICAL FIELD

The present invention is related to a hearing device and a method of adapting a hearing device.

### BACKGROUND OF THE INVENTION

Hearing devices are typically used to improve the hearing capability or communication capability of a user. A hearing device may pick up the surrounding sound with a microphone of the hearing device, process the microphone signal thereby taking into account the hearing preferences of the user of the hearing device and providing the processed sound signal into an ear canal of the user via a miniature loud speaker, commonly referred to as a receiver. A hearing device may also receive sound from an alternative input such as an induction coil or a wireless interface.

The degree of hearing loss, the possibility for user interaction (also referred as controls) and the product appeal of the hearing device (in particular the size of the hearing device) are different performance areas or rather quality dimensions which are not related to each other. Common behind the hear hearing devices (BTE) and canal receiver technology hearing devices (CRT) do not offer all flexibility to address different hearing device user needs as mentioned above.

In the prior art, user control elements are used in order to change the actual state of the hearing device, the volume and the beamforming thereof or just to ensure rapid interaction with the hearing device. However, with increased number of user control elements and the usability of the hearing device, the size of the hearing device is increasing as well. Each manual user control element which is added to the hearing device goes along with the disadvantage that the hearing device user has to wear a larger hearing device which gets uncomfortable.

Document WO 2015/041639 A1 describes a hearing device instrument having a control element adapted to be manipulated by the hearing device user. This document proposes to use a flexible substrate as part of the control element. Common hearing devices known in the state of the art offer low flexibility of user control element positioning in relation to user interaction performance. The size of the hearing device strongly depends on the number of user control elements and cannot be changed after the hearing device design is completed.

It is therefore an object of the present invention to provide a hearing device allowing to better match the product according to hearing device user's preferences.

### SUMMARY OF THE INVENTION

The present invention is directed to a hearing device comprising: an electronic module having at least one processor, a housing for accommodating the electronic module, and at least one user control assembly comprising at least one user control unit accessible by a user of the hearing device; said hearing device further comprising at least one connector interface operationally coupled to the electronic module, wherein: said user control assembly is detachably mounted to the housing, and said connector interface is adapted to receive inputs from a plurality of different user control assemblies and transfer said inputs to the electronic module via at least one coupling means.

The proposed hearing device allows to better match the product according to the needs or rather preferences of the hearing device user as a whole. In particular, the inventive hearing device allows to provide electrical connection from the user control assembly (comprising the at least one user control unit) to main electronics (in particular the at least one processor) at a comfortable or rather pleasing position. This advantage is achieved by way of flexible positioning of the user control assembly on the module. Hence, improved usability of the hearing device is achieved by way of a modular setup. As a whole, this advantage does not go along with increased overall size of the hearing device but offers the ability of having different positions for the user control assembly.

The inventive hearing device provides an electrical interface on the electronic module instead of having the user control assembly as part of the electronics and therefore in a defined position. The inventive provision of the electrical interface on the electronic module is in contrast to the state of the art in which the point of manual interaction is at the point of the electro mechanic contact element of the user control element. Hence, the prior art does not allow variability in position, size, functionality or appeal in one single hearing device. This limitation in the state of the art prevents from serving the hearing device users with individual needs in respect to tactility, usability, appeal, etc. Compared to the state of the art, the present invention offers the option to increase or decrease the functionality of the hearing device over time or price segments, which might be needed for experienced users, first time users and each and every hearing device user.

It is to be noted that the term user control assembly refers to at least one specific user control which can be an individual part, which is attachable to the electronic interface or housing of a hearing device. Additionally or as an alternative, the user control assembly can be located in the housing or in parts thereof comprised by the hearing device. In case of the housing of the hearing device is to be replaced, the required number and type of the at least one user control assembly can be changed in a flexible manner by the fitter or by the hearing device user itself.

The visible part of the user control assembly can be a soft or hard material, a molded piece, a touchscreen or any suited mechanical solution for best usability and tactility.

It is to be noted that the term connector interface relates to a means consisting of at least two electrical contacts such as pads, metal plates, springs, separated conductive areas, etc. The connector interface is operationally coupled to the electronic module. An electronic contact from a respective electric or electronic element, in particular the processor, to the user control assembly can be achieved by means of various connection techniques, such as spring contacts, zebra connectors, conductive rubbers, and/or further conductive elements or materials.

It is to be noted that the term coupling means relates to a respective electronic connection from a specific or rather individual point of user interaction to the at least one user control assembly. This electronic connection can be achieved by means of wires, a printed circuit board, solid contacts, springs, molded interconnection device (MID), 2D print or 3D print of conductive traces, etc.

In an embodiment of the proposed hearing device the connector interface is further adapted to transfer hearing device related notifications to the user control assembly for notifying the user. In this way the connector interface can be used both as input, for example user control, and output, for example at least one of LED, indicator, vibrating element, acoustic element, etc.

In a further embodiment of the proposed hearing device the connector interface comprises an electrical circuit and/or wireless transceiver coupled to the user control assembly. The electrical circuit can comprise at least one wire, a printed circuit board, etc. The wireless transceiver can comprise any wireless communication element comprising optic elements, inductive and/or capacitive elements, etc.

In a further embodiment of the proposed hearing device the user control assembly is formed as an individual part detachably coupled to the housing of the hearing device. In this way, variability in position, size, functionality or appeal in one single hearing device can be achieved.

In a further embodiment of the proposed hearing device the user control unit comprises at least one switching element. This switching element of the user control unit can be a mechanical switch, a capacitive element, a resistive element, a magnetic switch and/or any element adapted to change its electrical resistance within a desired range. A connector to the electronic module can comprise at least two connections.

In a further embodiment of the proposed hearing device the switching element comprises input/output means adapted to receive tactile inputs from the user and/or to output visible, audible and/or tactile notifications to the user. Hence, a switching element is provided which can both receive inputs as well as output notifications to the user. Therefore, a provision of two separate elements for receiving inputs and outputting notifications, respectively, can be omitted.

In a further embodiment of the proposed hearing device the switching element comprises at least one of a mechanical switch, capacitive element, magnetic switch and resistive element adapted to change electrical resistance within a predefined resistive range in response to user inputs. In this way, the switching element comprises both a pull-up function as well as a pull-down function. The pull-up function provides a connection with higher voltage, in particular power supply voltage, whereas the pull-down function provides a connection with reduced voltage, in particular ground voltage GND. In this embodiment, the contact is in a defined range within the predefined resistive range, i.e. from a minimum resistance (R min) to a maximum resistance (R max). This predefined resistive range, together with the switching element itself, can be interpreted by the electronic module of the hearing device as Low/High function. For example, a resistance of less than 20 kΩ (R<20 kΩ) can be defined as Low or closed, whereas a resistance of more than 200 kΩ (R>200 kΩ) can be defined as High or open. Therefore, a switching element is provided which can discriminate more than two switching states (solely On and Off). Therefore, the number of switching elements can be reduced resulting in a reduced size of the hearing device housing as well as in reduced costs.

In a further embodiment of the proposed hearing device the coupling means comprises electrical conductive means including at least one of a plurality of wires, a printed circuit board, solid contact, spring, molded interconnect device MID, and 2D print or 3D print of conductive traces. Hence, an improved user segment driven user interaction as well as an improved flexibility in design or rather appeal can be achieved. Further, a flexible compromise between usability and appeal is achieved.

In a further embodiment of the proposed hearing device the user control assembly comprises a cover, wherein the surface thereof mates with the surface of at least a portion of the housing.

In a further embodiment of the proposed hearing device the user control assembly is remotely located from the connector interface. In this way, the at least one connector interface can be made as part of the outer shell of the hearing device housing. This allows to increase the size of the volume control, to improve its tactile response and size, etc., for example. In doing so, in case of a wireless connection, the connector interface can even be completely decoupled from the electronic module. Hence, a much more improved flexibility in design of the hearing device can be achieved, since the connector interface does not require the same position for all form factors. In this way, increased freedom for component placement and industrial design is offered.

Moreover, the present invention is directed to a method of adapting a hearing device to hearing device user preferences, wherein said method comprises the steps of: providing a hearing device blank; determining a specific user control assembly preferred by the hearing device user among a plurality of user control assemblies; providing the hearing device blank with the determined specific user control assembly; and storing a respective configuration of the specific user control assembly in a fitting console comprised by the hearing device.

Hence, a method of adapting a hearing device is provided which allows improved matching of the product according to hearing device user's needs. Therefore, people with no or reduced needs for interaction controls, for example, can get a hearing device with no or a reduced number of control means with a positive impact on appeal of the hearing device (for example reduced size thereof). On the other hand, people with increased demand on interaction controls, for example, can get a specific configuration to control needs (for example solely a volume control) and specific tactile preferences, for example a more “robust” control button.

It is expressly pointed out that any combination of the above mentioned embodiments is subject of further possible embodiments. Only those embodiments are excluded that would result in a contradiction.

### BRIEF DESCRIPTION OF THE DRAWINGS

The present invention is further described with reference to the accompanying drawings jointly illustrating various exemplary embodiments which are to be considered in connection with the following detailed description. What is shown in the figures is:

FIG. 1 shows a schematic cross sectional view of a hearing device according to an embodiment of the invention; and

FIG. 2 shows a block diagram of a 4-pin connector.

### DETAILED DESCRIPTION OF THE INVENTION

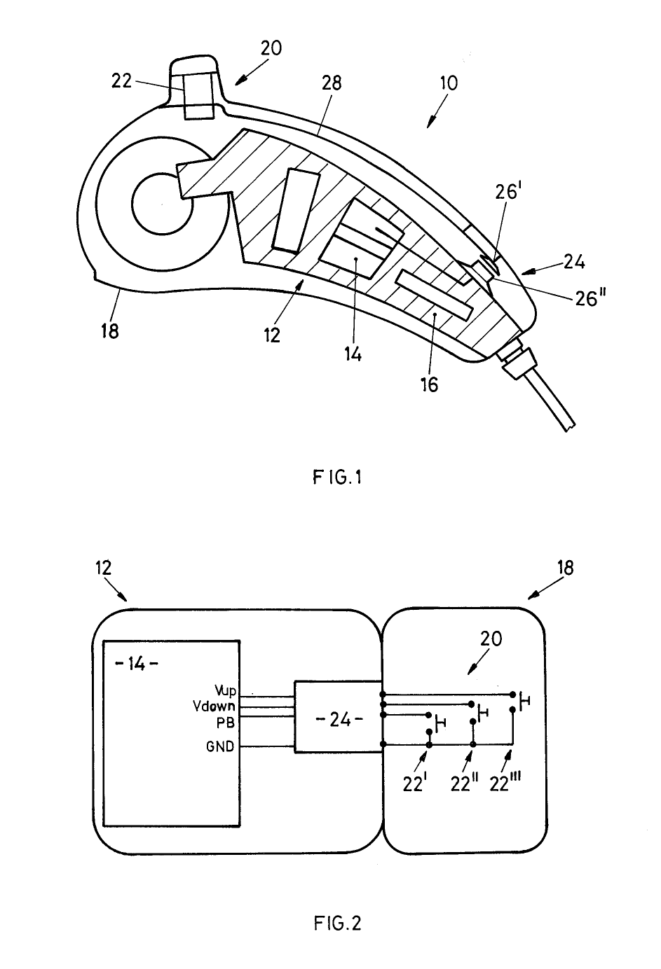

FIG. 1 shows a cross sectional view of a hearing device 10 according to an embodiment of the invention in a schematic illustration. The hearing device 10 comprises an electronic module 12 comprising at least one processor 14. The processor 14 can be fixedly installed on a printed circuit board 16 comprised by the electronic module 12. The hearing device 10 further comprises a housing 18 for accommodating at least the electronic module 12. The hearing device 10 further comprises a user control assembly 20 comprising at least one user control unit 22. The user control unit 22 is accessible from the outside of the housing 18 by a user of the hearing device 10. The user control assembly 20 is shown allocated in the housing 18. Hence, in case of replacing the housing 18, the required number and type of user control assemblies or rather user control units 22 can be changed in a flexible manner by the fitter and/or user of the hearing device 10 or during manufacturing thereof, for example. Hence, user's individual needs in respect of tactility, usability and appeal, for example, can be met. Further, functionality can be increased or decreased over time or price segments, which might be needed for experienced users or first time users.

The hearing device 10 further comprises a connector interface 24 coupled to the electronic module 12. The connector interface 24 comprises at least two electrical contacts 26′, 26″. Further, the electronic module 12 is connected to the user control assembly 20 by means of a coupling means 28, for example a wire, a line, etc. While not shown, the connection can be achieved by means of various further connection techniques, such as spring contacts, zebra connectors, conductive rubbers, further conductive elements or materials. The connector interface 24 can be used as input (e.g. at least one user control) or as output (e.g. at least one LED, indicator, vibrating element, acoustic element, etc.). While not shown, the connector interface 24 can comprise a wireless communication means comprising optic, inductive or capacitive element(s). As shown, the user control assembly 20 and the connector interface 24 are positioned remotely from each other.

In other words, advantageously, the user control assembly 20 can be placed independent from the position in which the switching occurs. Hence, the position of the user control assembly 20 can be chosen without any limitation. This involves an advantage which is unknown so far, since, in the prior art, the point of manual interaction is always at the point of the respective contact element. Hence, the inventive hearing device 10 is variable in position, size, functionality and/or appeal thereof.

The user control assembly 20 is detachably mounted to the housing 18 without changing the main part of the hearing device 10, for example its software. This feature provides an improved flexibility allowing to address different hearing device user needs as mentioned above.

The inventive hearing device 10 allows to better match with user needs. This is realized with the same electronic module 12 and different possibilities for positioning and attaching the user control assembly 20 according to hearing device user needs. This feature allows that all hearing device users with specific needs in terms of user's interaction or product appeal can benefit from the inventive hearing device 10. The connector interface 24 receives inputs from the user control assembly 20 and transfers said inputs to the electronic module 12 via at least one coupling means. While not shown, the connector interface 24 is able to transfer hearing device 10 related notifications to the user control assembly 20 notifying the hearing device user. As noted above, the connector interface 24 is coupled to the user control assembly 20 by means of the coupling means 28. While not shown, the connector interface 24 can be connected to the user control assembly 20 by means of a wireless connection.

FIG. 2 depicts a block diagram of a 4-pin connector adapted to connect the electronic module 12 to the housing 18 of the hearing device, which housing 18 comprises the user control assembly 20 (also refer to FIG. 1). As mentioned above, the user control assembly 20 comprises at least one user control unit 22′-22′″. One of connectors of each of said user control units 22′-22′″ are interconnected to each other, respectively. The interconnection thereof is routed via a connector interface 24 to a ground terminal of the processor 14 comprised by said electronic module 12. The remaining connectors of each of said user control units 22′-22′″ are connected to distinct ports of the connector interface 24, respectively.

The connector interface 24 routes signal states of said user control units 22′-22′″ to respective inputs of the processor 14. Said inputs comprise a push button (PB) input which is associated to a program change or any further command. The signal states of the remaining user control units 22″,22′″ are routed to a volume-down port and a volume-up port of the processor 14, respectively. Said ports are associated with commands or rather user inputs requesting decreased or increased volume. Hence, three different user inputs can be routed to the processor 14 by means of solely one single user control assembly 20. Therefore, contrary to the prior art, the provision of for example three different user control units can be omitted. Hence, the size of the hearing device as well as costs thereof can be reduced.

On the other hand, as an example, the size of a volume control element can be increased which would allow improved tactile response and size thereof. In addition to the command which could be input to the user control assembly 20, i.e. a push button (PB) command (a program change or any other command), an increased volume/reduced volume command, etc., further commands could be input to the user control assembly 20. As an example, said further commands can comprise an on/off command, an LED state or any other lines needed for LCD displays or external electronics driving other or additional controls.

1-11. (canceled)

12. A hearing device, the hearing device comprising:
an electronic module having at least one processor;
a housing configured to house the electronic module;
a user control assembly comprising a user control unit; and
a connector interface electronically coupled to the electronic module,
wherein:
the user control assembly is detachably mounted to the housing,
the connector interface is configured to receive inputs from a plurality of different user control assemblies and transfer the received inputs to the electronic module,
the connector interface is electronically coupled to the electronic module, and
the connector interface is also configured to transfer hearing device notifications to the user control assembly.

13. The hearing device of claim 12, wherein the connector interface comprises an electrical circuit or wireless transceiver electronically coupled to the user control assembly.

14. The hearing device of claim 12, wherein the user control assembly is formed as an individual part detachably coupled to the housing of the hearing device.

15. The hearing device of claim 12, wherein the user control unit further comprises a switching element.

16. The hearing device of claim 15, wherein the switching element configured to receive tactile inputs.

17. The hearing device of claim 16, wherein the switching element comprises at least one of the following:
a mechanical switch,
capacitive element, or
magnetic switch and resistive element adapted to change electric resistance within a resistive range in response to a user input.

18. The hearing device of claim 12, wherein electrical coupled includes at least one of the following
a plurality of wires,
a printed circuit board,
solid contact,
spring,
molded interconnect device, or
20 to 30 printed conductive traces.

19. The hearing device of claim 12, wherein the user control assembly further comprises a cover, wherein the surface thereof contacts the surface of a portion of the housing.

20. The hearing device of claim 12, wherein the user control assembly is remotely located from the connector interface.

21. A hearing device, the hearing device comprising:
an electronic module;
a user control assembly detachably mountable to a housing; and
a connector interface electronically coupled to the electronic module,
wherein:
the connector interface is configured to receive control signals from the user control assembly via a multiple pin configuration and transfer the control signals to the electronic module and the connector interface is connectable to other user control assemblies via the multiple pin configuration,
the connector interface is electronically coupled to the electronic module, and
the connector interface is also configured to transfer hearing device notifications to the user control assembly.

22. The hearing device of claim 21, wherein the hearing device is hearing aid, behind-the-ear (BTE) hearing aid, or an in-the-ear (ITE) hearing aid.
